(19) United States
(12) Patent Application Publication
(10) Pub. No.: US 2002/0087989 A1
(43) Pub. Date: Jul. 4, 2002

(54) Recording arrangement for the error-tolerant recording of an information signal

(76) Inventors: Adolf Proidl, Vienna (AT); Andras Kalmar, Rannersdorf (AT)

Correspondence Address: U.S. Philips Corporation, 580 White Plains Road, Tarrytown, NY, 10591, US

(21) Appl. No.: 10/015,836

(22) Filed: Nov. 30, 2001

(30) Foreign Application Priority Data
Dec. 4, 2000 (EP) 00890364.3

(51) Int. Cl. H04N 7/16; G06F 3/00; H04N 5/445; H04N 7/00; H04N 11/00; G06F 13/00; H04N 7/08

(52) U.S. Cl. 725/58; 725/47; 725/137; 348/461

(57) ABSTRACT

A recording arrangement (1) can be programmed to record an information signal (FS) of an information broadcast by the entry of a broadcast identification (VPS-SI, VPS-PI) and a broadcast start time (SBZ) transmitted in the information signal (FS). The recording mode of the recording arrangement (1) is activated both when the broadcast identification (VPS-SI, VPS-PI) is detected in the received information signal (FS) and when a recording start time (ABZ) is reached, which recording start time is reached a lead time interval (VZ) before the broadcast start time (SBZ-PI) of the programmed information broadcast. When during programming of the recording of the information broadcast a broadcast end time (SEZ) has been entered the recording mode of the recording arrangement (1) is deactivated only when, on the one hand, the broadcast identification (VPS-PI, VPS-SI) in the received information signal (FS) is not detected and when, on the other hand, a recording end time (AEZ) is reached, which recording end time is reached a trailing time interval (NZ) after the broadcast end time (SEZ) of the programmed information broadcast.

The invention relates to a recording arrangement for recording an information signal of an information broadcast programmed for recording and identified by a broadcast identification.

The invention further relates to a recording method for recording an information signal of an information broadcast programmed for recording and identified by a broadcast identification.

Such a recording arrangement and such a recording method are known from the document EP 0 492 298 A2. The known recording arrangement takes the form of a video recorder having recording means for recording a television signal of a programmed television broadcast. With the known video recorder a television broadcast selected by a user can be programmed for recording with the aid of a so-called VPT programming system, for which broadcast information (teletext) received in the television signal is displayed by means of a television set connected to the video recorder. The user can select the title of the desired television broadcast from the displayed program information, upon which a VPS code assigned to this television broadcast in the program information is stored in the recording control means of the video recorder.

For each television broadcast the VPS code identifying this television broadcast is transmitted in the television signal received by the receiving means of the video recorder. During the time that the VPS code identifying the television broadcast programmed for recording is received the recording control means activate the recording mode of the video recorder and the television broadcast desired and programmed by the user is recorded.

The known video recorder has error correction means for correcting an incorrect VPS code of the programmed television broadcast, which code is contained in the program information during the programming of the television broadcast to be recorded, in due time before the programmed television broadcast is received. For this purpose, the error correction means periodically check whether the VPS code of the programmed television broadcast, which is contained in the program information, has been changed by the television station. When the error correction means detect such a change of the VPS code, the changed VPS code of the programmed television broadcast is stored in the recording control means of the video recorder.

It has proved to be a drawback of the known recording arrangement and the known recording method that, unfortunately, incorrect VPS codes in the program information from the television station are corrected only rarely, as a result of which television broadcasts that are programmed with a broadcast identification, such as the VPS code, are often not recorded at all. Furthermore, the power consumption of the known video recorder is comparatively high as a result of the periodic scanning and testing of the program information. Therefore, a “low-power standby mode”, which is greatly appreciated by users, cannot be realized with the known video recorder.

It is an object of the invention to provide a recording arrangement of the type defined in the first paragraph, with which the aforementioned drawbacks are precluded. In order to achieve this object with such a recording arrangement characteristic features in accordance with the invention are provided, in such a manner that the recording arrangement can be characterized in the manner defined hereinafter.

A recording arrangement for the error-tolerant recording of an information signal of an information broadcast programmed for recording and identified by a broadcast identification and a broadcast start time, having receiving means for receiving the information signal in which information broadcasts and associated broadcast identifications can be transmitted, and having recording means for recording the received information signal on a record carrier in a recording mode of the recording arrangement, and having recording control means for activating the recording mode when either the broadcast identification of the programmed information broadcast is detected in the information signal or a recording start time of the programmed information broadcast is reached, which recording start time is reached a lead time interval before the broadcast start time of the programmed information broadcast.

It is another object of the invention to provide a recording method of the type defined in the second paragraph, with which the aforementioned drawbacks are precluded. In order to achieve this object with such a method characteristic features in accordance with the invention are provided, in such a manner that the recording method can be characterized in the manner defined hereinafter.

A recording method for the error-tolerant recording of an information signal of an information broadcast programmed for recording and identified by a broadcast identification and a broadcast start time, in which the following steps are performed: receiving the information signal in which information broadcasts and associated broadcast identifications can be transmitted; recording the received information signal when a recording mode is active; activating the recording mode when either the broadcast identification of the programmed information broadcast is detected in the information signal or a recording start time of the programmed information broadcast is reached, which recording start time is reached a lead time interval before the broadcast start time of the programmed information broadcast.

This has the advantage that a recording mode is obtained which is both time controlled and controlled by the broadcast identification and which makes it possible to achieve a very high reliability of successfully recording the programmed television broadcast. Thus, the beginning of the programmed television broadcast is also recorded if the broadcast identification stored in the recording control means or received in the information signal is incorrect or if the television broadcast has already been transmitted partly or wholly before the recording start time owing to a change of the television broadcasting schedule. The provision of a lead time interval results in an even higher probability that the desired television broadcast is recorded successfully.

The measures defined in claim 2 and claim 13 have the advantage that the programmed television broadcast is also recorded till the end if the broadcast identification stored in the recording control means or received in the information signal is incorrect or if the television broadcast is transmitted partly or wholly after the recording end time. The provision of a trailing time interval results in an even higher probability that the desired television broadcast is recorded successfully.

The measures defined in claim 3 have the advantage that information signal portions which are received with a broadcast identification and which can thus be assigned to an information broadcast with a high probability are already marked by marking information during the recording of the information signal.

The measures defined in claim 4 and in claim 5 have the advantage that after the recording of the programmed television broadcast offline analysis means analyze the recorded information signal and to use all the information thus made available in order to mark the recording area of the record carrier where the desired television broadcast has actually been recorded for subsequent reproduction of the recorded television broadcast. This has the advantage that other recording areas of the record carrier can be released for the recording of further television broadcast s, as a result of which an effective utilization of the storage capacity of the record carrier is obtained.

The measures defined in claim 6 have the advantage that even if the broadcast identification of the programmed television broadcast is incorrect the advantages of a correctly timed activation of the recording mode are obtained owing to the preceding broadcast identification.

The measures defined in claim 7 have the advantage that even if the broadcast identification of the programmed television broadcast is incorrect the advantages of a correctly timed deactivation of the recording mode are obtained owing to the subsequent broadcast identification.

The measures defined in claim 8 have the advantage that even if the programmed information broadcasts are received in recording time intervals for different information signals which overlap, which overlap may be caused by the lead time interval and the trailing time interval, a complete recording of both programmed information broadcasts is guaranteed.

The measures defined in claim 9 have the advantage that by the selection of a desired television broadcast from the received program information the user stores the sequence of the broadcast identifications, the broadcast identification of the programmed television broadcast as well as the broadcast start time and the broadcast end time of the programmed television broadcast in the recording arrangement. Thus, the information required for the recording control means as well as the information for the offline analysis means are stored in the recording arrangement.

The measures defined in claim 10 provide a recording arrangement which has the advantage that a plurality of information broadcasts can be recorded in parallel at the same time. The invention will now be described in more detail hereinafter with reference to an embodiment which is shown in the drawings by way of example but to which the invention is not limited.

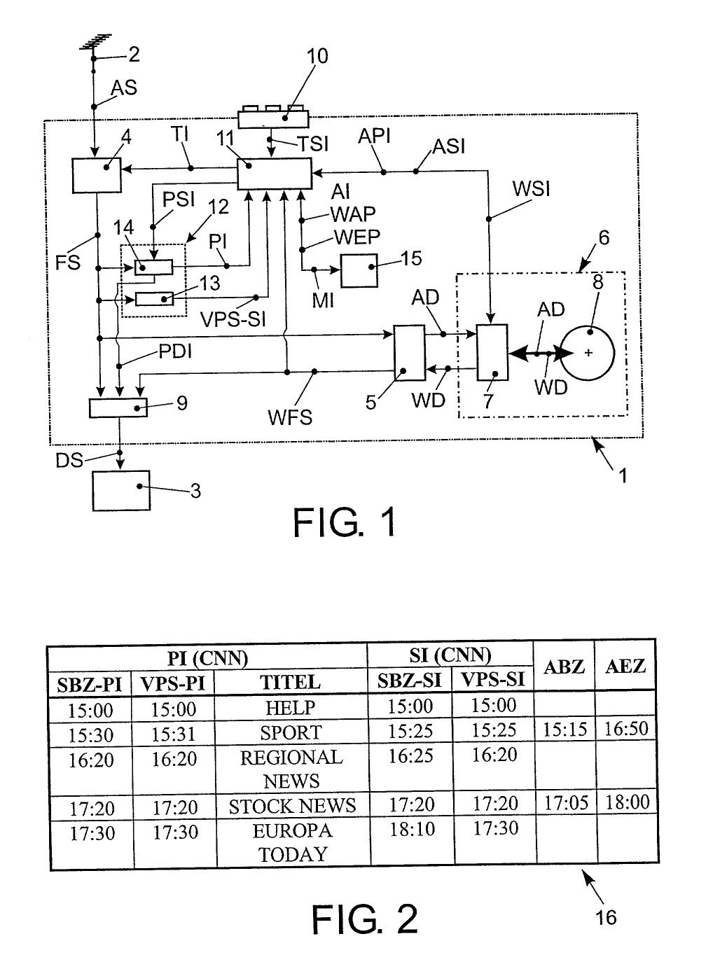

FIG. 1 shows a hard disk recorder 1, which forms a recording arrangement for the error-tolerant recording of a television signal of a television broadcast programmed for recording.

FIG. 2 shows a recording table stored in memory means of the hard disk recorder shown in FIG. 1.

FIG. 1 shows a hard disk recorder 1, to which an antenna 2 and a television set 3 are connected. An antenna signal AS, supplied from the antenna 2 to the hard disk recorder 1, can be applied to an analog tuner 4 of the hard disk recorder 1. The tuner 4 thus forms receiving means for receiving an information signal formed by a television signal FS. The antenna signal AS transmits a plurality of television signals FS from different broadcasting stations, such as for example CNN or ARD. Tuner information TI, which identifies one of these stations, can be applied to the tuner 4. The tuner 4 is adapted to supply the television signal FS received in the antenna signal AS and identified by the tuner information TI.

The hard disk recorder 1 includes a signal processing stage 5, to which the tuner 4 supplies the television signal FS. The signal processing stage 5 is adapted to process the television signal FS and to supply digital recording data AD. The processing of the television signal FS required for this purpose is common knowledge to one skilled in the art.

The hard disk recorder 1 has recording means 6, which include a hard disk stage 7 and a hard disk 8 as a record carrier and which are adapted to record the recording data AD of a television broadcast in a recording mode of the hard disk recorder 1. In the recording mode of the hard disk recorder 1 the hard disk stage 7 receives recording control information ASI, upon which the hard disk stage 7 records the recording data AD, supplied by the signal processing stage 5, on the rotating hard disk 8 with the correct time relationship and in the correct format. The hard disk stage 7 then supplies recording position information API, which identifies the current recording position on the hard disk 8. The processings required for this by the hard disk stage 7 are known to one skilled in the art.

Recording data AD recorded on the hard disk 8 can be reproduced as reproduction data WD in a reproducing mode of the hard disk recorder 1. In the reproducing mode of the hard disk recorder 1 the hard disk stage 7 receives reproduction control information WSI, upon which the hard disk stage 7 reads reproduction data WD from the hard disk 8 from a reproduction start position WAP defined by the reproduction control information WSI up to a reproduction end position WEP defined by the reproduction control information WSI. Reproduction data WD read by means of the hard disk stage 7 are processed by the signal processing stage 5 and supplied as a reproduced television signal WFS.

The hard disk recorder 1 further has output means 9, to which the television signal FS from the tuner 4 and the reproduced television signal WFS from the signal processing means 5 can be supplied. Depending on the mode of operation of the hard disk recorder 1 the output means 9 supply either the television signal FS or the reproduced television signal WFS to the television set 3 as the reproduction signal DS.

The hard disk recorder 1 further has keypad 10 and control means 11. By actuating a key of the keypad 10 a user of the hard disk recorder 1 can activate the recording mode and by actuating another key of the keypad 10 the user can activate the reproducing mode of the hard disk recorder 1. Key control information TSI, which identifies one of these modes of operation, can be applied to the control means 11, which in response thereto supply either the recording control information ASI or the reproduction control information WSI to the hard disk stage 7.

By the actuation of keys of the keypad 10 it is further possible to select a broadcasting station whose television signal FS should be filtered out of the antenna signal AS by the tuner 4. Subsequently, the tuner information TI identifying this broadcasting station can be supplied to the tuner 4 by the control means 11.

The television signal FS supplied by the tuner 4 also includes additional information. The television signal FS also conveys a VPS code VPS-SI, which forms a broadcast identification and which identifies the television broadcast currently transmitted by means of the television signal FS. The VPS code VPS-SI is laid down in the standard ETS 300 231. The television signal FS conveys further additional information formed by an “Electronic Program Guide”, which contains program information PI for the television broadcasts which can be received in the coming week and which are transmitted by different broadcasting stations, in television signals FS that can be received with the aid of the tuner 4. The “Electronic Program Guide” is defined in the standard ETS 300 707.

The hard disk recorder 1 further has decoder means 12 adapted to evaluate the additional information included in the received television signal FS. For this purpose, the decoder means 12 include a VPS decoder stage 13 and an EPG decoder stage 14. The VPS decoder stage 13 is adapted to extract the VPS code VPS-SI from the television signal FS supplied by the tuner 4 and to supply the extracted VPS code VPS-SI to the control means 11. The EPG decoder stage 14 is adapted to extract the program information PI from the television signal FS supplied by the tuner 4 and to supply the extracted program information PI to the control means 11.

By means of the keys of the keypad 10 it is further possible to activate a recording scheduler mode, in which the program information PI decoded by the EPG decoder stage 14 is applied to the output means 9 as program display information PDI and is supplied from said output means to the television set 3 as a display signal DS. When the hard disk recorder 1 is in the recording scheduler mode the control means 11 can supply program control information PSI to the EPG decoder stage 14, by means of a title of a television broadcast, which title is displayed by the television set 3, can be selected in order to mark this television broadcast for later recording of the television signal FS of this television broadcast as a programmed television broadcast. The keypad 10, the control means 11 and the EPG decoder stage thus form recording scheduler means.

The hard disk recorder 1 further has memory means 15 with the aid of which information included in the program information PI and relating to the programmed television broadcast is stored. For this purpose, the control means 11 read the title, an expected broadcast start time SBZ-PI and an expected VPS code VPS-PI of the programmed television broadcast from the program information PI. Furthermore, an expected broadcast end time SEZ-PI of the programmed television broadcast is determined, which corresponds to the expected broadcast start time SBZI-PI of the television broadcast that follows the programmed television broadcast. The title and the expected VPS code VPS-PI of the programmed television broadcast are stored in the memory means 15.

The control means 11 now form recording control means and are adapted to determine a recording start time ABZ and a recording end time AEZ. The recording start time ABZ is reached a lead time interval VZ of 15 minutes before the expected broadcast start time and the recording end time AEZ is reached a trailing time interval NZ of 30 minutes after the expected broadcast end time SEZ-PI of the programmed television broadcast. The recording start time ABZ and the recording end time AEZ of the programmed television broadcast are stored in the memory means 15.

The control means 11 are adapted to activate the recording mode of the hard disk recorder 1 either when the expected VPS code VPS-PI of the programmed television broadcast corresponds to the VPS code VPS-SI received from the VPS decoder stage 13 or when the recording start time ABZ of the programmed television broadcast is reached.

This has the advantage that a time-controlled as well as a broadcast-identification controlled recording mode of the hard disk recorder 1 is obtained, which enables the programmed television broadcast to be recorded successfully with a very high probability. Thus, the beginning of the programmed television broadcast is also recorded if the VPS code VPS-PI stored in the memory means 15 or the VPS code VPS-SI received in the television signal FS is incorrect, or if the television broadcast is partly or wholly transmitted before the recording start time ABZ as a result of a change of the television broadcasting schedule. The provision of a lead time interval VZ results in an even higher probability for the successful recording of the programmed television broadcast. These advantages will be set forth in more detail hereinafter with reference to two examples of use of a hard disk recorder 1.

The control means 11 are now adapted to deactivate the recording mode of the hard disk recorder 1 when both the expected VPS code VPS-PI of the programmed television broadcast does not correspond to the VPS code VPS-SI received from the VPS decoder stage 13 and the recording end time AEZ of the programmed television broadcast has already been reached or is exceeded.

This has the advantage that the programmed television broadcast is also recorded till the end if the VPS code VPS-PI stored in the memory means 15 or the VPS code VPS-SI of the programmed television broadcast, as received in the television signal FS, is incorrect, or if the television broadcast is partly or wholly transmitted after the recording end time AEZ as a result of a delay. The provision of a trailing time interval NZ results in an even higher probability for the successful recording of the desired television broadcast. These advantages will be set forth in more detail hereinafter with reference to two examples of use of a hard disk recorder 1.

FIG. 2 shows a recording table 16 with the aid of which the two examples of use of the hard disk recorder 1 will be elucidated. In the first example of use it is assumed that the user of the hard disk recorder 1 wishes to program the television broadcast entitled “SPORTS” for recording, which television broadcast is to be broadcast next day by the broadcasting station CNN. For this purpose, the user activates the recording scheduler mode of the hard disk recorder 1 and selects the title of this television broadcast from the titles displayed on the television set.

Subsequently, the control means 11 determine the following information about the programmed television broadcast from the program information PI supplied by the EPG decoder stage 14: title =“SPORTS”; expected broadcast start time SBZ-PI=“15:30”; expected VPS code VPS-PI=“15:31”; expected broadcast end time SEZI-PI=“16:20”. Furthermore, the control means 11 determine the recording start time ABZ =SBZ-PI—15 minutes =“15:15” and the recording end time AEZ=SEZ-PI+30 minutes=“16:50”. Subsequently, the title, the expected VPS code VPS-PI, the recording start time ABZ and the recording end time AEZ are stored in the memory means 15 and the recording scheduler mode is terminated.

The day on which the programmed television broadcast is to be broadcast the control means 11 now check whether one of the VPS codes VPS-SI successively included in the television signal FS from the broadcasting station CNN corresponds to the stored VPS code VPS-PI=“15:31”, or whether the recording start time ABZ=“15:15”has already been reached. If one of these two situations has occurred the control means 11 activate the recording mode.

In the first example of use it is assumed that the programmed television broadcast entitled “SPORTS” is already broadcast from 15:25, i.e. 5 minutes early, because the preceding television broadcast entitled “HELP” took less time. Furthermore, it is assumed that, as a result of an error by the technical staff of the broadcasting station CNN, the VPS code VPS-SI=“15:25” actually transmitted during the programmed television broadcast “SPORTS” is incorrect.

The control means 11 now detect at the instant 15:15 hours that the recording start time ABZ=“15:15” determined and stored for the programmed television broadcast “SPORTS” is reached and activate the recording mode of the hard disk recorder 1. Subsequently, starting from the instant 15:15 hours the television signal FS from the broadcasting station CNN is recorded on the hard disk 8 as recording data AD, which signal contains 10 minutes of the television broadcast “HELP” followed by the television broadcast “SPORTS”.

The test of the actually received VPS code VPS-SI shows that none of the received VPS codes VPS-SI corresponds to the expected VPS code VPS-PI, for which reason the programmed television broadcast “SPORTS” is recorded in a time-controlled fashion. At the instant 16:50 hours the control means 11 detect that the recording end time AEZ=“16:50” determined and stored for the programmed television broadcast “SPORTS” is reached and deactivate the recording mode of the hard disk recorder 1.

This has the advantage that the television signal FS recorded from 15:15 till 16:50 hours contains the whole television broadcast “SPORTS” and the user can play back this television broadcast at a later instant. If this television broadcast “SPORTS” had been programmed with the VPS code VPS-PI=“15:31” on a commercially available video recorder, this video recorder would not have activated the recording mode anyway, because the VPS code VPS-PI included in the program information PI would not have been transmitted. If this television broadcast “SPORTS” had been programmed with the broadcast start time SBZ=15:30 and with the broadcast end time SEZ=16:20 on a commercially available video recorder, this video recorder would not have recorded only a part of the programmed television broadcast, which would also be disadvantageous.

The control means 11 of the hard disk recorder 1 now also form marking means which, in the recording mode of the hard disk recorder 1, are adapted to store the recording position information API supplied by the hard disk stage 7 as marking information MI if the VPS code VPS-SI received in the television signal FS changes. Thus, at 15:25 hours first marking information MI1 is stored in the memory means 15 because at this instant the VPS code VPS-SI changes from VPS-SI=“15:00” to VPS-SI=“15:25”. Likewise, second marking information MI2 is stored in the memory means 15 at 16:25 hours because at this instant the VPS code VPS-SI changes from VPS-SI=“15:25” to VPS-SI=“16:20”.

The control means 11, the memory means 15 and the recording means 6 now form offline analysis means which are adapted to analyze the recorded television signal FS after deactivation of the recording mode and to mark television signal portions of the recorded television signal FS which have common characteristics with marking information MI. Characteristics of the television signal FS to be analyzed are, for example, a picture frequency, velocity information of objects of the picture content, text information of the picture content, color information of the picture content or sound information of the recorded television signal FS. These types of analyzing a television signal FS are known, for example, from commercial message detection devices, which have been described in a multitude of publications.

After the deactivation of the recording mode the control means 11 first compare the expected duration of the programmed television broadcast FS of 50 minutes (=16:20- 15:30=50) with the duration of the television signal portions recorded between respective items of marking information MI. The control means 11 then detect that the greatest correspondence exists with the duration of 60 minutes (=16:25- 15:25=60) of the television signal portion recorded between the first marking information MI1 and the second marking information MI2 and define the recording position on the hard disk 8 identified by the first marking information MI1 as the reproduction start position WAP and the recording position on the hard disk 8 identified by the second marking information MI2 as the reproduction end position WEP.

Subsequently, the control means 11 activate the reproducing mode and analyze the television signal WFS reproduced before and after the first marking information MI1 and the second marking information MI2. The control means 11 then check whether a picture frequency could point to a commercial. The control means 11 further check whether text information can be detected in the picture information, which could point to the title of a television broadcast, i.e. to the beginning of a new television broadcast. The control means 11 further carry out tests, which are known to one skilled in the art, in order to define the reproduction start position WAP and the reproduction end position WEP of the programmed television broadcast in such a manner that with the highest possible probability exactly the programmed television broadcast is recorded from the recording position on the hard disk 8, as identified by the reproduction start position WAP, up to the recording position on the hard disk 8, as identified by the reproduction end position WEP.

This has the advantage that when the user activates the reproducing mode for the reproduction of the recorded television broadcast “SPORTS”, only this television broadcast is reproduced and the initially recorded end of the television broadcast “HELP” and the beginning of the television broadcast “REGIONAL NEWS” are not reproduced. Moreover, the advantage is obtained that the recording areas in which the television signal FS of television broadcast s has been recorded which the user did not wish to be recorded can be released for the recording of further television broadcast s. This release may be effected upon confirmation by the user but also automatically.

In a second example of use it is assumed that the user of the hard disk recorder 1 wishes to record the television broadcast “STOCK NEWS” and programs this television broadcast in the recording scheduler mode. Thereupon, the following information is stored in the memory means 15: title =“STOCK NEWS”; expected broadcast start time SBZ-PI=“17:20”; expected VPS code VPS-PI=“17:20”; expected broadcast end time SEZI-PI=“17:30”; recording start time ABZ=SBZ-PI—15 minutes=“17:05” and the recording end time AEZ=SEZ-PI+30 minutes=“18:00”.

In the second example of use it is assumed that the television broadcast “STOCK NEWS” has been prolonged considerably on account of very topical news from the stock exchange and is broadcast till 18: 10 hours. Advantageously, the recording mode is not stopped when the recording end time is reached at 18:00 hours, as a result of the fact that the VPS code VPS-SI=“17:20” is received, but is ended when the actual end of this television broadcast is reached at 18:10 hours. Thus, the recording control means of the hard disk recorder 1 make particularly advantageous use of the advantages of both the time-controlled recording and the broadcast-identification controlled recording of a programmed television broadcast, while the respective drawbacks of the respective other recording mode are avoided.

It is to be noted that the control means could also extract the expected VPS code VPS-PI of the television broadcast scheduled before and after the television broadcast to be recorded from the program information PI and store this in the memory means 15. Thereupon, the control means could activate the recording mode when the VPS code VPS-SI included in the received television signal FS no longer corresponds to the expected VPS code VPS-PI of the television broadcast scheduled before the television broadcast to be recorded. Likewise, the control means could deactivate the recording mode when the VPS code VPS-SI included in the received television signal FS for the first time corresponds to the expected VPS code VPS-PI of the television broadcast scheduled after the television broadcast to be recorded.

This would have the advantage that even when the expected VPS code VPS-PI of the television broadcast to be recorded is incorrect or when the actually received VPS code VPS-SI of the television broadcast to be recorded is incorrect a recording mode is obtained which is controlled by the received broadcast identification.

It is to be noted that it is advantageous to include a second tuner in the recording arrangement so as to make it possible that even in the case two programmed television broadcast s which overlap in time and which are broadcast by different broadcasting stations both television broadcast s can be recorded completely.

It is to be noted that a recording arrangement in accordance with the invention can also be adapted to record the recording data AD on other record carriers, such as for example a magnetic tape, an optical medium or similar media. However, a record carrier in the form of a hard disk is particularly advantageous.

It is to be noted that the recording arrangement could also be adapted to receive, process and record digital information signals. Furthermore, the additional information (broadcast identification, program information) could alternatively be received via additional receiving means, for example from the internet.

It is to be noted that the lead time interval VZ can be only a few seconds but also several hours. Likewise, the trailing time interval NZ can be only a few seconds but also several hours.

It is to be noted that the information signal can also be a signal which includes an audio signal, a signal which includes text information or a signal which includes further information.

It is to be noted that the broadcast identification, the broadcast start time/recording start time and the broadcast time/recording end time may also be entered by a user with the aid of the keys of the keypad.

1. A recording arrangement (1) for the error-tolerant recording of an information signal (FS) of an information broadcast programmed for recording and identified by a broadcast identification (VPS-PI) and a broadcast start time (SBZ-PI), having receiving means (4) for receiving the information signal (FS) in which information broadcasts and associated broadcast identifications (VPS-SI) can be transmitted, and having recording means (6) for recording the received information signal (FS) on a record carrier (8) in a recording mode of the recording arrangement (1), and having recording control means (11) for activating the recording mode when either the broadcast identification (VPS-PI, VPS-SI) of the programmed information broadcast is detected in the information signal (FS) or a recording start time (ABZ) of the programmed information broadcast is reached, which recording start time is reached a lead time interval (VZ) before the broadcast start time (SBZ-PI) of the programmed information broadcast.

2. A recording arrangement (1) as claimed in claim 1, in which the end of the programmed information broadcast is defined by a broadcast end time (SEZ-PI) and in which the recording control means (6) are adapted to deactivate the recording mode when both the absence of the broadcast identification (VPS-PI, VPS-SI) of the programmed information broadcast is detected and a recording end time (AEZ) of the programmed information broadcast is reached, which recording end time is reached a trailing time interval (NZD) after the broadcast end time (SEZ-PI) of the programmed information broadcast.

3. A recording arrangement (1) as claimed in claim 1, in which marking means (11) are provided, which marking means are adapted, in the recording mode of the recording arrangement (1), to store marking information (MI) defining the current recording position (API) on the record carrier (8) when the broadcast identification (VPS-SI) received in the information signal (FS) changes.

4. A recording arrangement (1) as claimed in claim 1, in which offline analysis means (11) are provided, which analysis means are adapted, after deactivation of the recording mode, to analyze the recorded information signal (WFS) and to mark information signal portions of the recorded information signal (WFS) which have common characteristics with marking information (MI), the characteristics to be analyzed being, for example, a picture frequency, velocity information of objects of the picture content, text information of the picture content, color information of the picture content or sound information of the recorded information signal (WFS).

5. A recording arrangement (1) as claimed in claim 3 or claim 4, in which the offline analysis means (11) are adapted to define stored marking information (MI) as a reproduction start position (WBP) and/or to define stored marking information (MI) as a reproduction end position (WEP) of the information broadcast recorded in the recording means (6).

6. A recording arrangement (1) as claimed in claim 1, in which the recording control means (11) are adapted to activate the recording mode when the broadcast identification (VPS-PI) of the information broadcast transmitted before the programmed information broadcast is no longer detected in the sequence of broadcast identifications (VPS-SI) included in the received information signal (FS).

7. A recording arrangement (1) as claimed in claim 1, in which the recording control means (11) are adapted to deactivate the recording mode when the broadcast identification (VPS-PI) of the information broadcast transmitted after the programmed information broadcast is already detected in the sequence of broadcast identifications (VPS-SI) included in the received information signal (FS).

8. A recording arrangement as claimed in claim 1, in which further receiving means for receiving a further information signal are provided, in which further information signal further programmable information broadcasts and associated broadcast identifications can be transmitted.

9. A recording arrangement (1) as claimed in claim 1, in which recording scheduler means (10, 11, 14) are provided by which an information broadcast to be recorded can be programmed and which are adapted to evaluate electronic program information (PI) received by the receiving means (4), which electronic program information includes both broadcast start times (SBZ) and the expected sequence of broadcast identifications (VPS-PI) of the information broadcasts to be expected in the information signal (FS) to be recorded.

10. A recording arrangement (1) as claimed in claim 1, in which the record carrier (8) takes the form of a hard disk.

11. A recording arrangement (1) as claimed in claim 1, in which the recording control means include VPS decoder means (13) for decoding a VPS code which forms the broadcast identification.

12. A recording method for the error-tolerant recording of an information signal (FS) of an information broadcast programmed for recording and identified by a broadcast identification (VPS-PI) and a broadcast start time (SBZ-PI), in which the following steps are performed:
receiving the information signal (FS) in which information broadcasts and associated broadcast identifications (VPS-SI) can be transmitted;
recording the received information signal (FS) when a recording mode is active;
activating the recording mode when either the broadcast identification (VPS-PI, VPS-SI) of the programmed information broadcast is detected in the information signal (FS) or a recording start time (ABZ) of the programmed information broadcast is reached, which recording start time is reached a lead time interval (VZ) before the broadcast start time (SBZ-PI) of the programmed information broadcast.

13. A recording method as claimed in claim 12, in which the end of the programmed information broadcast is defined by a broadcast end time (SEZ-PI) and in which the recording mode is deactivated when both the absence of the broadcast identification (VPS-PI, VPS-SI) of the programmed information broadcast is detected and a recording end time (AEZ) of the programmed information broadcast is reached, which recording end time is reached a trailing time interval (NZ) after the broadcast end time (SEZ-PI) of the programmed information broadcast.
